(19) United States
(12) Patent Application Publication
(10) Pub. No.: US 2026/0197636 A1
(43) Pub. Date: Jul. 9, 2026

(54) Apparatus and Method for Receiving Rights-Protected Content Using a Vehicle

(71) Applicant: Bayerische Motoren Werke Aktiengesellschaft, Muenchen (DE)

(72) Inventors: Carl Ebbinghaus, Muenchen (DE); Martin Wagner, Haimhausen (DE)

(21) Appl. No.: 19/128,473

(22) PCT Filed: Aug. 16, 2023
(86) PCT No.: PCT/EP2023/072516

§ 371 Date: May 8, 2025

(30) Foreign Application Priority Data
Nov. 15, 2022 (DE) 10 2022 130 138.9

(51) Int. Cl. H04W 12/033; H04L 9/08; H04L 9/30; H04W 12/043

(52) U.S. Cl. CPC H04W 12/033; H04L 9/0825; H04L 9/30; H04W 12/043; H04L 2209/84

(57) ABSTRACT

A vehicle includes a communications interface, an arithmetic logic unit, and an output unit. The communications interface receives rights-protected digital content encrypted with a key, which has been stored on a server external to the vehicle. The ALU decrypts the digital content encrypted with the key using a private key to form decrypted digital content. The key and the private key constitute a key-pair. The output unit provides the decrypted digital content. The vehicle is further configured to transmit the key of the key-pair via the communications interface to a mobile-radio terminal assigned to the vehicle, in order to induce the mobile-radio terminal to request and to download the digital content with the key from the external server. The vehicle also receives the digital content encrypted with the key from the mobile-radio terminal.

The present application is the U.S. national phase of PCT Application PCT/EP2023/072516 filed on Aug. 16, 2023, which claims priority of German patent application No. 10 2022 129 841.8 filed on Nov. 15, 2022, the entire contents of which are incorporated herein by reference.

### TECHNICAL FIELD

The disclosure relates generally to vehicles, and more particular, to receiving rights-protected digital content, encrypted with a key, using a vehicle.

### BACKGROUND

For the purpose of protection against unlawful dissemination of rights-protected contents, the latter are encrypted with a key when being retrieved/downloaded by a user, in order to enable decryption merely for the authorized user with a corresponding, individual (private) key. In order to be able to load the rights-protected digital content, the application has to solicit the content, suitably encrypted for it, from a server with a public key that has been assigned to the application. The digital content is then encrypted with the public key of the application and is transmitted directly to the requesting application. The requesting application can decrypt the encrypted digital content with its private key. Depending on the type of the digital content, in some cases a very high consumption of data arises by virtue of the requesting and loading of the encrypted content.

Although modern vehicles are frequently provided with a mobile-radio interface, with the possibility to with other communications communicate directly subscribers, for example with servers external to the vehicle and/or with mobile-radio subscribers, the mobile-radio interfaces have, as a rule, not been provided by the manufacturer for the purpose of transmitting large amounts of data. The background to this is the data contract that has been set up for the mobile-radio interface, which with respect to the amount of data to be transmitted is limited for reasons of cost.

In order to be able to reproduce rights-protected content in a vehicle, the rights-protected content might therefore, for instance, be requested and loaded from a mobile-radio terminal, assigned to the vehicle, at the server. After the loading and decrypting of the encrypted content by the mobile-radio terminal, the decrypted content might then be transmitted to an output unit of the vehicle. However, this is frequently not possible, since the holder of the rights to the digital content does not permit the output of the decrypted content via an interface of the device decrypting the digital content, and prohibits this by technical means.

There exists a need, therefore, for a motor vehicle and a method for receiving rights-protected digital content by means of a vehicle, which are functionally improved and able to utilize existing mechanisms for digital rights management.

### SUMMARY

The above-described need, as well as others, are addressed by at least some aspects and embodiments described herein.

According to a first aspect, a vehicle includes a communications interface, an arithmetic logic unit and an output unit. The communications interface has been set up to receive rights-protected digital content, encrypted with a key, which has been stored on a server external to the vehicle. By “digital content”, audio data and/or video data are understood. Audio files are, for instance, songs, voice data, podcasts, etc. In the case of video data, it may be a question of videos, movies, streams, games and such like. Video data also encompass, as a rule, audio data matching the moving images. The arithmetic logic unit has been set up to decrypt digital contents encrypted with the key by using a private key. The key with which the digital content has been encrypted and the private key constitute a key-pair. In particular, the key with which the digital content has been encrypted is a public key of the key-pair. The output unit has been set up to output the digital content decrypted with the private key. The output unit may accordingly comprise one or more loudspeakers and/or one or more display units. Display units in a vehicle are, in particular, video screens for the control display in the center console or on, or in, the dashboard, or separate video screens that, for the rear passengers for instance, have been fastened to the roof-liner and/or to the seat-backs of the front seats.

The vehicle is distinguished in that for the purpose of receiving the rights-protected digital content, encrypted with the key, it has been designed to transmit the key of the key-pair via the communications interface to a mobile-radio terminal assigned to the vehicle, in order to induce the mobile-radio terminal to request and to download the content with the key from the external server. Furthermore, the vehicle has been designed to receive the rights-protected digital content, encrypted with the key, from the mobile-radio terminal.

The communications interface, via which the key is transmitted to the mobile-radio terminal and the encrypted digital content is received from the mobile-radio terminal, comprises a wireless and/or a hard-wired interface. The wireless interface has been designed, in particular, for short-range communication and is based, for example, on WLAN, Bluetooth, etc. The hard-wired interface utilizes a cable connection to the mobile-radio terminal, for example a cable via which the mobile radio telephone is simultaneously supplied with current from the on-board network of the vehicle.

Since the digital content has been encrypted with the (public) key of the vehicle, the vehicle is capable of decrypting the encrypted digital content by using its private key. The procedure can utilize existing mechanisms for rights digital management without amendments, without having to utilize the mobile-radio interface of the vehicle for the purpose of loading the digital content. By a “mobile-radio interface”, an interface is to be understood, via which a connection to for example according to the mobile-radio network, transmission standards 3G, 4G, LTE, etc., is established.

The mobile-radio terminal—which is, in particular, a smartphone, a tablet PC, a smartwatch or some other computer pertaining to a user of the vehicle—is consequently utilized as a proxy, acting on behalf of the vehicle, in order to load the digital content. This procedure makes it possible not to have to utilize data contracts assigned to the mobile-radio interface of the vehicle for the download of the digital content. Instead of this, the mobile-radio terminal pertaining to the user of the vehicle can be utilized for the loading of large amounts of data, the loading of high amounts of data being, as a rule, no problem for the mobile-radio terminal by virtue of suitable data contracts.

At the same time, by virtue of the proposed procedure it is ensured that the rules for protection of rights, established by the holders of the rights to the digital content, are not violated. In particular, no amendment to the system, known hitherto, of digital rights management is required.

The key-pair comprising the (public) key and the associated private key has expediently been assigned to an application running in the vehicle. This makes it possible to reproduce the rights-protected encrypted digital content via the output unit of the vehicle, even though the soliciting and loading of the digital content is undertaken via another device (generally: a protagonist).

The key-pair that comprises the (public) key and the associated private key has expediently been stored in a key-management unit of the vehicle. This unit has been designed to manage the key-pair. It will be understood that the key-management unit may encompass a large number of key-pairs for managing differing rights contents, or said key-pairs may be stored in this unit. The management of the key-pair may also involve the storage of the public key temporarily or permanently (additionally) in the mobile-radio terminal assigned to the vehicle.

It is expedient, furthermore, if the vehicle includes a user interface and has been designed to transmit the key to the mobile-radio terminal in response to a user input via the user interface, and to solicit and load the digital content from the server. In other words, the user of the vehicle initiates the transfer of the key to the mobile radio telephone by an input on the user interface of the vehicle.

If at the time of the user input the public key has been stored in the mobile-radio terminal assigned to the vehicle, an item of information can be transmitted to the mobile-radio terminal, in response to the user input, to attach the public key to the request message with which the digital content is to be solicited and loaded, or to integrate said public key into said request message.

Alternatively, the vehicle may have been designed to transmit the key to the mobile-radio terminal in response to a solicitation of the mobile-radio terminal, the solicitation resulting from a user input to the mobile-radio terminal. In this configuration variant, the user of the vehicle operates his/her mobile-radio terminal in order to initiate there, for instance, the loading of digital content and the subsequent reproduction on the output unit of the vehicle. In this case, the mobile-radio terminal transmits a message to the vehicle which then, as a reply to this message, transmits the key to the mobile-radio terminal, in order to induce the latter to request and to download the content with the key from the external server.

If at the time of the user input the public key has been stored in the mobile-radio terminal assigned to the vehicle, an item of information can be transmitted to the mobile-radio terminal, in response to the solicitation of the mobile-radio terminal, to attach the public key to the request message with which the digital content is to be solicited and loaded, or to integrate said public key into said request message.

According to a second aspect, a method receives rights-protected digital content, encrypted with a key, by means of a vehicle. The vehicle includes, as described above, a communications interface for receiving rights-protected digital content encrypted with a key, which has been stored on a server external to the vehicle, an arithmetic logic unit for decrypting the digital content encrypted with the key by using a private key, in which connection the key and the private key constitute a key-pair, and also an output unit for outputting the digital content decrypted with the private key.

The method includes the steps of transmitting the key of the key-pair via the communications interface to a mobile-radio terminal assigned to the vehicle, in order to induce the mobile-radio terminal to request and to download the content with the key from the external server. The method further includes the step of receiving the rights-protected digital content, encrypted with the key, from the mobile-radio terminal.

The method has the same advantages as were described above in connection with one or more embodiments of the vehicle of the first aspect.

The vehicle expediently includes a user interface, the key being transmitted to the mobile-radio terminal in response to a user input via the user interface.

If at the time of the user input the public key has been stored in the mobile-radio terminal assigned to the vehicle, an item of information is transmitted to the mobile-radio terminal, in response to the user input, in order to induce the mobile-radio terminal to attach the public key to the request message with which the digital content is to be solicited and loaded, or to integrate said public key into said request message.

Alternatively, the vehicle transmits the key to the mobile-radio terminal in response to a solicitation of the mobile-radio terminal, the solicitation resulting from a user input on the mobile-radio terminal.

If at the time of the user input the public key has been stored in the mobile-radio terminal assigned to the vehicle, an item of information is transmitted to the mobile-radio terminal, in response to the solicitation of the mobile-radio terminal, in order to induce the mobile-radio terminal to attach the public key to the request message with which the digital content is to be solicited and loaded, or to integrate said public key into said request message.

Lastly, the disclosure encompasses a computer-program product which comprises instructions that, upon execution of the program by a computer, induce the computer to execute the steps of the method described herein, or of a configuration thereof. The term “computer” here encompasses the totality of the units involved in the vehicle for the purpose of carrying out the method, in particular the arithmetic logic unit, the communications interface, the output unit and, where appropriate, the key-management unit.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic representation of a vehicle according to an exemplary embodiment, and also of a mobile-radio terminal assigned to the vehicle, which has been set up to request and to download data from a server; and

FIG. 2 shows a flowchart which illustrates the receiving of rights-protected digital content, encrypted with a key, by a vehicle.

### DETAILED DESCRIPTION

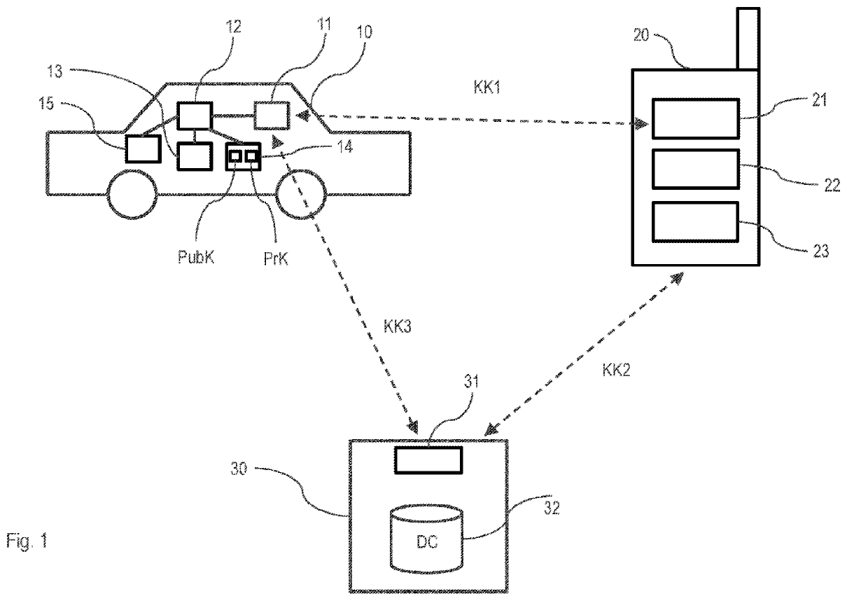

FIG. 1 shows a schematic representation of a vehicle 10 according to an exemplary embodiment, of a mobile-radio terminal 20 assigned to the vehicle 10, and of a server 30 on which digital content DC has been stored. The digital content DC comprises, in particular, audio data and/or video data. Audio files are, for instance, songs, voice data, podcasts, etc. In the case of video data, it may be a question of videos, movies, streams, games and such like. Video data also encompass, as a rule, audio data matching the moving images. The digital content DC is rights-protected content, the protection of which is based on an asymmetric cryptosystem. For this purpose, key-pairs that consist of a public key PubK and an associated private key Prk are utilized in known manner in a so-called public-key encryption method. The mode of operation of such a public-key encryption method, just like the mode of operation of digital rights management, is known to a person skilled in the art and will therefore not be elucidated any further at this point.

The rights-protected digital content DC has been stored in a memory 32 of a server 30, from which it can be solicited and loaded by an application. The server 30 includes a communications interface 31 and processing means, not represented in any detail, for processing requests which are received in the form of request messages AN. In accordance with the known principle of digital rights management, the application soliciting and loading the digital content DC transmits the public key PubK in the request message to the server 30. The server 30 processes the request message AN and encrypts the digital content DC with the public key PubK, contained in the request message AN, for the application. The digital content VDC appropriately encrypted in this way is then transmitted to the application. The application can then decrypt the encrypted digital content VDC with the private key Prk associated with the public key. The public key PubK and the private key Prk constitute the key-pair that, in accordance with the principle, has been assigned to the application or to a user for the digital content DC. The key-pair has been stored in a memory that is accessible for the application.

In the example described here, the digital content DC is to be reproduced by the vehicle. For this purpose, an application running in the vehicle 10 might send (communications channel KK3 in FIG. 1) the request message AN directly to the server 30 via a mobile-radio interface, not represented, in accordance with the principle described above. By a “mobile-radio interface”, an interface is to be understood via which a connection to the mobile-radio network, for example according to transmission standards 3G, 4G, LTE, etc., is established. For this purpose, a data contract assigned to the mobile-radio interface of the vehicle 10 would have to be utilized for the download of the digital content DC. This can be avoided with the procedure according to at least some embodiments, described in the following, without having to deviate from the basic principles of digital rights management.

To this end, the mobile-radio terminal 20 in this embodiment is utilized as a proxy, acting on behalf of the vehicle 10, in order to load the digital content DC.

For this purpose, the vehicle 10 includes a communications interface 11. The communications interface 11 comprises a wireless and/or a hard-wired interface with which a communication (an exchange of data) with the mobile-radio terminal 20 is made possible. The wireless interface has been designed, in particular, for short-range communication and is based on, for example, WLAN, Bluetooth, etc. The hard-wired interface utilizes a cable connection to the mobile-radio terminal 20, for example a cable via which the mobile-radio terminal is simultaneously supplied with current from the on-board network of the vehicle. Appropriate interfaces are known to a person skilled in the art. As will be elucidated further below, the rights-protected and encrypted digital content VDC is received from the mobile-radio terminal 20 via the communications interface 11.

The vehicle 10 further includes an arithmetic logic unit which has been set up to decrypt the encrypted digital content VDC received from the mobile-radio terminal 20 by using the aforementioned private key PrK. The decrypted digital content DC can then be reproduced on an output unit 13 of the vehicle. For this purpose, the output unit 13 comprises one or more loudspeakers and/or one or more video screens.

The vehicle 10 includes in addition, in known manner, a user interface 15 which comprises input means and output means. The user interface 15 may have been realized, for instance, in the form of a touchscreen and/or physical buttons and/or a video screen and/or lights. Any combination of input devices and output devices is possible.

The aforementioned key-pair, which comprises the (public) key PubK and the private key Prk, has been saved in a key-management unit 14 of the vehicle. The key-management unit 14 can store a large number of key-pairs. The key-management unit 14 may be, for instance, a specific memory area of the arithmetic logic unit 12, or may access this memory area.

Each key-pair is associated with a specific combination of digital content DC and application, or user. This means that differing key-pairs are held in readiness for differing digital contents DC. As a rule, a key-pair has been assigned to a specific user, for example to the user of the vehicle. In other words, the digital content is encrypted in application-specific manner with the respective public key PubK of the key-pair. The key-pair may also have been assigned to the vehicle 10.

The mobile-radio terminal 20 represented in FIG. 1 is a mobile-radio terminal pertaining to the user of the vehicle, which has been assigned to the vehicle 10. The assignment of the mobile-radio terminal 20 to the vehicle 10 can be effected, for instance, by coupling the components with one another. The mobile-radio terminal 20 may be a conventional smartphone, a tablet PC, a smartwatch or such like. The mobile-radio terminal 20 includes, in known manner, a communications interface 21 and also a user interface 22 which comprises input means and output means. The user interface 22 may have been realized, for instance, in the form of a touchscreen and/or physical buttons. Similarly, instead of a touchscreen a combination of video screen and buttons or other input means may also be present.

Via its communications interface 21, the mobile-radio terminal 20 can communicate (communications channel KK1) with the communications interface 11 of the vehicle 10 and can thereby exchange data. Similarly, the mobile-radio terminal 20 has been set up to exchange data (communications channel KK2) with the server 30 via a communications interface 23. The communications interface 23 is, in particular, a mobile-radio interface via which a connection to the mobile-radio network, for example according to transmission standards 3G, 4G, LTE, etc., is established. For this purpose, a data contract assigned to the mobile-radio terminal 20 has, as a rule, been concluded. The communication between the mobile-radio terminal 20 and the server 30 might also be based on WLAN.

In order to be able to reproduce rights-protected and encrypted digital content VDC in the vehicle 10, the public key PubK of the key-pair is transmitted via the communications interface 11 of the vehicle 10 to the mobile-radio terminal 20 assigned to the vehicle 10. The transmission of the public key PubK is effected together with, or in, a request message AN which induces the mobile-radio terminal 20 to request and to download the digital content DC with the public key PubK from the external server 30.

The downloading of the digital content DC, which has then been encrypted with the public key PubK of the vehicle or, of the application running in the vehicle, is then loaded from the mobile-radio terminal 20 via communications link KK3. Subsequently the encrypted digital content VDC is transmitted to the vehicle 10 via communications link KK2.

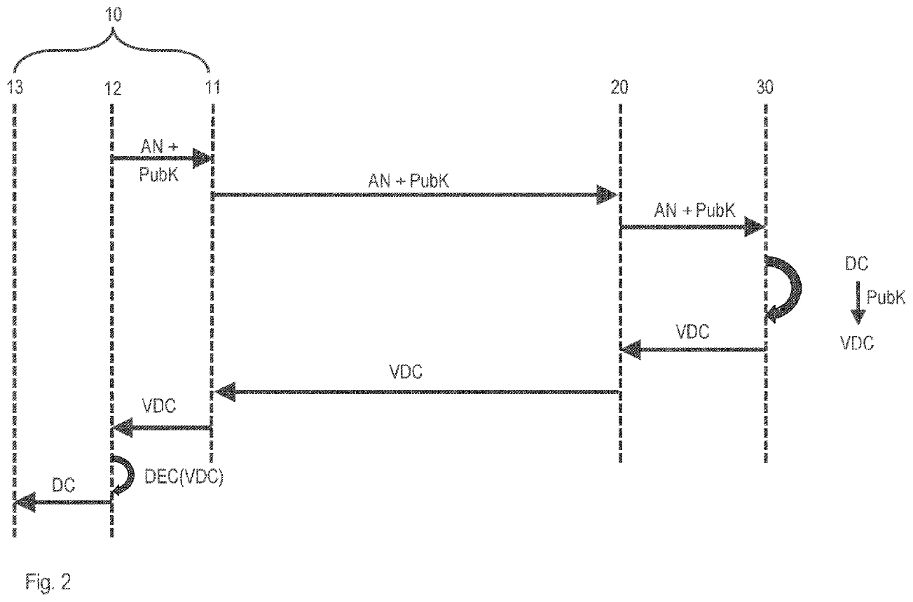

The communications interface 11 forwards the encrypted digital content VDC to the arithmetic logic unit 12 for decryption using the private key Prk of the key-pair, which was transmitted to the mobile-radio terminal 20. The decrypted digital content DC can then be output on the output unit 13 of the vehicle. This is visualized in FIG. 2.

The starting-point of the loading of rights-protected content DC is a request message AN of the arithmetic logic unit 12, which includes the public key PubK which has been assigned to the vehicle—or, to be more exact, to the application running in the vehicle—and to the digital content DC to be loaded.

The trigger to transmit the request message AN with the public key PubK from the vehicle 10 to the mobile-radio terminal 20 for the purpose of requesting digital content may be the ascertainment of a user input via the user interface 15 of the vehicle 20. If the arithmetic logic unit 12 ascertains such a user input via the user interface 15, the request message and the public key PubK are transmitted to the mobile-radio terminal 20. Alternatively, the request message and the public key PubK are transmitted to the mobile-radio terminal 20 if a corresponding user input to the mobile-radio terminal 20 was ascertained. These two variants represent user interactions that can optionally be undertaken either on control elements of the vehicle 10 or on the user interface of the mobile-radio terminal 20.

In a further alternative configuration, the trigger for transmitting the public key PubK to the mobile-radio terminal 20 may also occur automatically by means of artificial intelligence, such as, for example, upon detection of a specific location, of a specific route section, of a specific day and/or time, or of specific other events. This automatic detection, which, for instance, can occur with aid the of artificial intelligence, can take place both in the vehicle 10 and in the mobile-radio terminal 20.

A further configuration provides that the public key PubK has been stored temporarily or permanently in the mobile-radio terminal assigned to the vehicle, in which connection the request message AN to be sent to the server is generated by the mobile-radio terminal 20, and the public key PubK is added to this message, when one of the aforementioned events (detection of an operation of the user interface of the vehicle 10 or of the mobile-radio terminal 20, or automatic detection by means of artificial intelligence) obtains.

The message AN containing the public key PubK is then transmitted to the mobile-radio terminal 20 via the communications interface 11 of the vehicle 10. The mobile-radio terminal 20 receives the request message AN via its communications interface 21, and forwards this message unchanged via its communications interface 22 to the server 30. If the public key PubK is added to the request message AN by the mobile-radio terminal, the request message is modified or supplemented where AN appropriate.

The server 30 encrypts the requested content DC held in its data memory 32 with the public key PubK contained in the request message AN, as a result of which the encrypted digital content VDC is obtained. The encrypted digital content VDC is transmitted from the server 30 to the mobile-radio terminal 20, and from there is routed back to the vehicle 12.

After the encrypted digital content VDC has been received by the communications interface 11, it is transmitted to the arithmetic logic unit 12 for decryption (DEC) by the arithmetic logic unit 12. After the decryption, the decrypted digital content DC is forwarded to the output unit 13 for output.

The procedure that has been described consists in that the application in the motor vehicle that would like to output a specific digital content forwards the public key PubK assigned to it to a mobile-radio terminal which acts as a proxy. The mobile-radio terminal requests the digital content from the server with the (from the perspective of the mobile-radio terminal) “foreign” public key, and downloads it, in order then to forward it to the original application pertaining to the vehicle. Only this application running in the vehicle is then capable of playing the digital content, since only it has access to its private key.

In a concrete example, a video application (video app) in the vehicle can utilize an app running on the mobile-radio terminal, and therefore the mobile-radio terminal, as a proxy. The video app of the vehicle forwards its public key to the app of the mobile-radio terminal which then takes care of the request and the download of the digital content. The encrypting and playing are then undertaken by components of the vehicle. The loading of the digital content can be effected by means of a communication between the mobile-radio terminal and the vehicle, for instance via WLAN or Bluetooth, without burdening a mobile-radio link with data.

### LIST OF REFERENCE SYMBOLS

10 vehicle
11 communications interface
12 arithmetic logic unit
13 output unit
14 key-management unit
15 user interface
20 mobile-radio terminal
21 first communications interface
22 user interface
23 second communications interface
30 server
31 communications interface
32 data memory
DC unencrypted digital content
VDC encrypted digital content
PubK (public) key
PrK private key
AN request message

1.-11. (canceled)

12. A vehicle, comprising:
a communications interface configured to receive rights-protected digital content encrypted with a key, which has been stored on a server external to the vehicle;
an arithmetic logic unit configured to decrypt the digital content encrypted with the key by using a private key to form decrypted digital content, wherein the key and the private key constitute a key-pair;
an output unit configured to output the decrypted digital content;
wherein the vehicle is further configured to,
transmit the key of the key-pair via the communications interface to a mobile-radio terminal assigned to the vehicle, in order to induce the mobile-radio terminal to request and to download the digital content with the key from the external server;
receive the digital content encrypted with the key from the mobile-radio terminal.

13. The vehicle as claimed in claim 12, wherein the key with which the digital content has been encrypted is a public key of the key-pair.

14. The vehicle as claimed in claim 12, wherein that the key-pair, comprising the key and the private key, has been assigned to an application running in the vehicle.

15. The vehicle as claimed in claim 12, further comprising a key-management unit configured to store the key-pair and to manage the key-pair.

16. The vehicle as claimed in claim 12, further comprising a user interface, and wherein the vehicle is configured to transmit the key to the mobile-radio terminal responsive a user input received via the user interface.

17. The vehicle as claimed in claim 12, wherein the vehicle is configured to transmit the key to the mobile-radio terminal in response to a solicitation by the mobile-radio terminal, the solicitation resulting from a user input on the mobile-radio terminal.

18. The vehicle as claimed in claim 12, wherein the encrypted digital content comprises at least one of the group consisting of audio data and video data.

19. The vehicle as claimed in claim 18, wherein the key with which the digital content has been encrypted is a public key of the key-pair.

20. The vehicle as claimed in claim 19, wherein that the key-pair, comprising the key and the private key, has been assigned to an application running in the vehicle.

21. The vehicle as claimed in claim 20, further comprising a key-management unit configured to store the key-pair and to manage the key-pair.

22. A method for receiving rights-protected digital content encrypted with a key using a vehicle, wherein the vehicle includes a communications interface configured to receive rights-protected digital content encrypted with a key, which has been stored on a server external to the vehicle, and an arithmetic logic unit configured to decrypt the digital content encrypted with the key by using a private key, wherein the key and the private key constitute a key-pair, the method comprising:
transmitting the key of the key-pair via the communications interface to a mobile-radio terminal assigned to the vehicle, in order to induce the mobile-radio terminal to request and to download the content with the key from the external server; and
receiving the rights-protected digital content encrypted with the key from the mobile-radio terminal.

23. The method as claimed in claim 22, wherein the vehicle includes a user interface, and wherein transmitting the key of the key-pair further comprises transmitting the key to the mobile-radio terminal in response to a user input via the user interface.

24. The method as claimed in claim 22, wherein transmitting the key further comprises transmitting the key to the mobile-radio terminal in response to a solicitation of the mobile-radio terminal, the solicitation resulting from a user input on the mobile-radio terminal.

25. The vehicle as claimed in claim 22, wherein the encrypted digital content comprises at least one of the group consisting of audio data and video data.

26. The vehicle as claimed in claim 22, wherein that the key-pair, comprising the key and the private key, has been assigned to an application running in the vehicle.

27. A non-transitory storage medium storing a computer-program comprising instructions that, upon execution of the program by a computer, induce the computer to execute the method as claimed in claim 22.
